(19) United States
(12) Patent Application Publication
(10) Pub. No.: US 2008/0178565 A1
(43) Pub. Date: Jul. 31, 2008

(54) EQUINE HOOD WITH MANE AND FORELOCK ACCESS

(76) Inventor: David J. Hershberger, Mogadore, OH (US)

Correspondence Address: DAVID J. HERSHBERGER, 1721 RANDOLPH RD., MOGADORE, OH, 44260, US

(21) Appl. No.: 11/627,974

(22) Filed: Jan. 28, 2007

Related U.S. Application Data
(60) Provisional application No. 60/766,645, filed on Feb. 2, 2006.

(51) Int. Cl. B68C 5/00

(52) U.S. Cl. 54/79.1

(57) ABSTRACT

A fitted hood for equines with openings over the Forelock and Mane allow access to the Mane while on the horse. The hood conforms to the shape of the head allowing ears to protrude through openings at the poll and muzzle through a corresponding muzzle opening. The neck section of the hood conforms closely to the neck so not to snag or become a hazard to the horse. A body section may be constructed separately and connected to the hood or the hood may be made as one head, neck, and body covering form fitted to the body covering from withers to rump. Head, neck, and body portions of the hood keep dust, dirt and insects away from the horse and provide warmth in cool weather. A chest to chin opening allow the hood to be removed without disrupting completed bands or braids.

This application claims the priority of Provisional Patent Application No. 60/766,645 (pending) filed on Feb. 2, 2006.

### BACKGROUND OF THE INVENTION

1. Field of the Invention

The present invention relates to equine clothing. Equine clothing has been constructed for many uses such as protecting the horse from airborne dust, stall dust, and rain. Coverings are also used to keep horses warm, dry, and protected from sun, and insects (primarily biting flies). Various types and styles of hoods have been developed for these purposes.

2. Background

Equine clothing is used to cover the horse head, head and neck, head, neck and shoulders, or head, neck, shoulders, and back; depending on the style and configuration of article used.

Often times horse owners want to cover their animals for protection including animals that are left outdoors in the daytime which become susceptible to the sun's rays, rain, and bugs and insects such as biting files. Covering the horse with clothing will provide protection from sunburn, dampness, and the diseases caused by insects.

Horse clothing also provides protection for the animal from dust and debris. This is particularly helpful for owners who want to show their animal in a horse show, contest, or parade and need them to remain clean during the time between bathing the animal and when they remove the covering for the show itself.

Paragraphs 6 and 7 depict the horse clothing as it will allow the horse protection as specified. It is the invention highlighted in this article which will allow the owner access to the horse's Mane and Forelock by way of operational zippers or closures and still allow the aforementioned protection from dust, sun, rain, and biting insects without removing the covering from the horse. A chest to chin zipper allows the article to be removed without disrupting braids or bands when ready to show the animal.

Several documents have been found that disclose articles of animal clothing that would afford the general protection characteristics of the article stated above. None of those clothing articles found in previous documents offer the ability to allow access to the Mane or Forelock while the article is on the animal.

In U.S. Des. Pat. No. 6,574,948 ('948), titled ILLUMINATIVE SAFETY GARMET FOR WORKING ANIMAL, there is shown a horse blanket with neck and head covering. The clothing depicted is a horse blanket that drapes the horse covering the head, neck, and body descending to just above the horse's knees. While the article of clothing protects the horse from dirt, rain, and biting insects, it does not allow access to the horse's Mane and Forelock without removing the article from the horse which would be preferred by a user who is showing the animal in competition. It also does not appear to be stretchable which will allow the article to “give” in the areas of the Mane and Forelock when braided or banded allowing them to remain neat and intact.

Similar to design of '948, is that disclosed in U.S. Pat. No. 5,361,563 ('563), titled HORSE COVERING. This article is intended as a one-piece turn-out blanket to protect the animal from the cold weather while turned out to pasture. This inventor finds the same limitations in this patent as in '948, including the facts that both of these articles are not stretchable and do not have operational openings for access to the Mane and Forelock while the article is on the horse.

In U.S. Pat. No. 6,128,891 ('891), titled PROTECTIVE HORSE MASK, the inventor provides a mask which is limited to covering the horse's head. The invention is intended to be used as a protective article from the sun and irritating insects around the eye area. The invention is limited in several ways including the fact that it is confined to the face area only, it is open and will not keep dust and debris off the horse's face, and although there is an opening for the Forelock, the Forelock is left open and is not able to be covered. The preferred invention would allow the horse's neck down to withers and as an alternative full body to be protected and also allow not only access to the Forelock and Mane but coverage and protection of the finished product after the Forelock and Mane are braided or banded.

The most relevant article would be U.S. Pat. No. 4,823,540 ('540), titled STRETCHABLE ONE-PIECE HOOD. This embodiment is a stretchable hood or blanket which protects the horse from dust and insects and covers the Mane and Forelock of the animal. The article is limited in that it does not have operational openings or any openings for access to the Mane and Forelock while the article is on the horse. If this article is placed on the horse, the article would have to be removed from the horse, then the horse would be braided or banded, finally the article would be pulled back over the horse possibly disrupting the completed work on the Mane and Forelock. The preferred embodiment of this application would have Mane and Forelock openings which are closed with zippers or Velcro®. It would also have an opening from chest to chin to allow the preferred embodiment to be fully opened and removed from the horse again without disrupting the completed braiding or banding.

### BRIEF SUMMARY OF THE INVENTION

The current invention has overcome several deficiencies of the earlier art by providing a well ventilated, insect protective, light-weight garment for horses. Four objectives are satisfied by this invention: first it provides an article which allows access to the Mane and access to the Forelock of animals such as those used for showing in competitions, parades, or for pleasure riding; second the article not only allows access to the Mane and Forelock but the Mane and Forelock openings are able to be completely closed securely by Velcro® or a zipper; third it allows the article to be completely opened from chin to chest and removed over the horse's head after braiding or banding; without disrupting the completed work; and fourth, the Mane opening is now a defined area of the covering which can be used as an advertisement area for the user to display; the owner's name, the horse's name, the club or other group affiliation, websites, or other general or specific advertisements.

The first, second, and fourth of these objectives is attained by providing an opening over the Mane and Forelock during manufacturing that will allow the user to unzip or un-Velcro® the opening, pull back the material in that area, and work with the Mane or Forelock. When the user has completed work, they zip or Velcro® the opening closed to not only protect the completed work but to secure it in place and train it to lie in the desired position close to the neck. This has also now defined the area of the horse's Mane in such a manner to “frame out” a section on the horse which is now extremely visible and draws attention to the horse where advertising space is now available in a manner that has not been used before.

The third objective is satisfied by inserting a zipper in the garment from chin to the chest parallel to the neck line ending in the area just before the two front legs. This zipper can be opened completely separating the article and allowing the article to be removed from the horse's head without disrupting the braiding or banding.

### BRIEF DESCRIPTION OF THE SEVERAL VIEWS OF THE DRAWING

FIG. 1 is a perspective view of a horse wearing a body cover including an equine hood with Mane and Forelock access.

FIG. 2 is a partial view showing a horse's head wearing an equine hood with Forelock access; closed view.

FIG. 3 is a full view of a horse wearing an equine hood with Mane and Forelock access; open view.

FIG. 4 is a partial view showing a horse's head with an equine hood with Forelock access; open view.

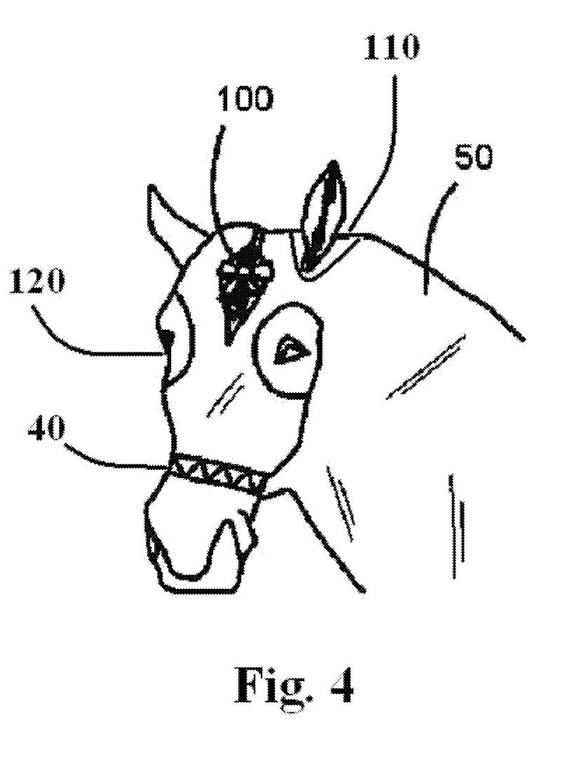

FIG. 5 is a top plan full open view of an equine hood only, according to one embodiment.

### DESCRIPTION OF THE PREFERRED EMBODIMENTS

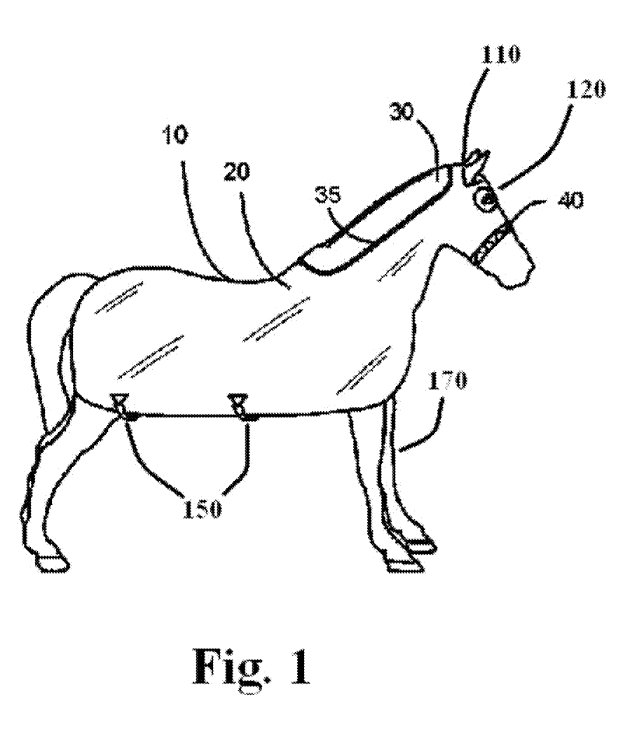

FIG. 1 is a perspective view of a horse wearing a body cover including an equine hood with Mane and Forelock access.

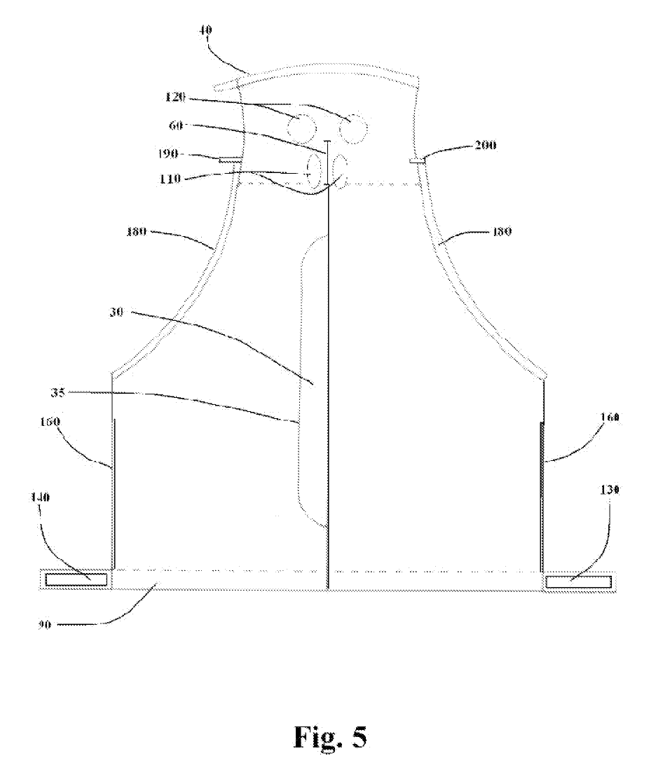

As shown, the hood and body covering 20, is shown placed about the horse's head encasing the face and fitted in a conforming manner to the head and neck regions. The muzzle of the horse is placed through the noseband 40 which is encircled with a padded material which is stitched to the inner part of the noseband to reduce irritation and increase comfort during use of the article. Beginning at the withers, the body covering runs the length of the body and drapes over the horse covering to the top of the legs and just below the belly region. At the belly region, there are two straps 150 fitting loosely to hold the covering secure about the body. The primary strap 90 is a body strap made of elastic and fitting around the circumference of the horse just above the withers and posterior to the front legs 170. The body strap is secured to itself with Velcro®. The hook side 130 is secured snuggly to its counterpart loop side 140 as shown in FIG. 5.

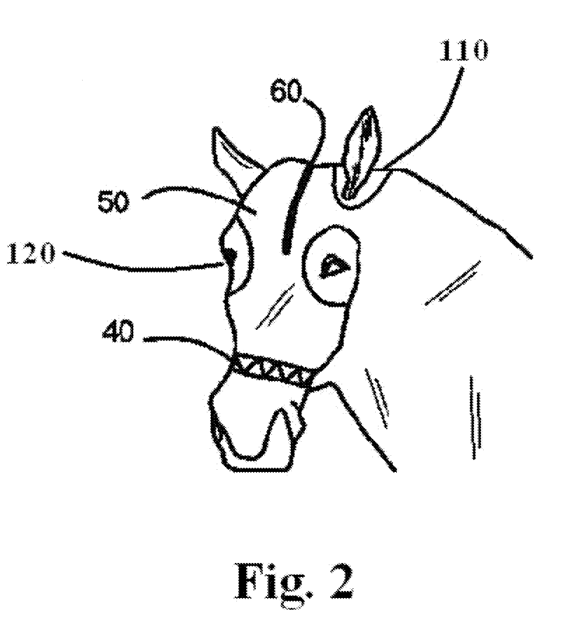

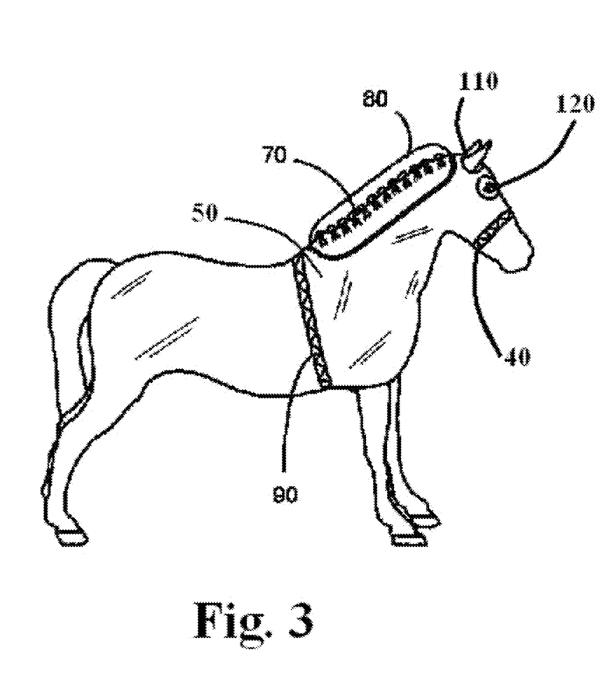

According to embodiments, there are openings in the article such as 35, 60, and 180 which can be secured with a method of closure such as zipper, Velcro®, snaps, or other suitable closure that will hold the article in such position as described on the horse. The three areas are described as follows: 35 is an opening which resides directly adjacent to the Mane of the horse running parallel to the neck and when opened allows access to the Mane while the article is on the horse and secures 30, FIG. 1, or 80 FIG. 3 which are depictions of the Mane cover. When closed, 30 protects the Mane keeping it clean and maintained in a braided, banded, flat or other manner specified by the user and now “frames out” a section on the horse where the user can advertise the owner's name, the horse's name, the club or other group affiliation, websites, or other general or specific advertisements. Second is 60, FIG. 2, an opening which resides over the Forelock of the horse above and between the eyes and between the ears and allows access to the Forelock while the article is on the horse. When closed, 60 protects the Forelock keeping it clean and maintained in a braided, banded, flat or other manner specified by the user. The third opening is 180, FIG. 5, preferably a zipper closure running from chin to the chest running parallel to the neck and ending before the front legs 170. This closure must be strong enough to support the amount of pressure that is applied to the closure from the stretchable material and when drawn closed will assist in “training” the Mane to lie in a flat position and will assist in holding the braided or banded Mane securely. Opening 180 can be used when placing the hood on any horse but particularly that horse which may be frightened of placing its head into an article. The article is completely opened about 180 as the zipper separates into two pieces. The article is placed on the head of the animal, and then zipper 180 is zipped from chest back up to chin slowly as not to frighten the animal. Zipper 180 is secured closed with Velcro® hook end 190 and loop end 200. The hook and loop Velcro® will not only secure the zipper in the closed position, but will also assure that the zipper tag will not stick or poke the horse or rub the chest in an irritative manner. The inverse is also possible when ready to remove the article without disrupting the completed braids or bands 70, FIG. 3. The article can be completely opened and removed over the head of the animal without the need to draw the head through the article frightening the animal and creating an unsafe situation.

According to embodiments, the hood with Mane (35) and Forelock (60) opening may be constructed as a single full body style covering 20, FIG. 1. Or, the hood can be a separate modular article in its entirety 50, FIG. 3. Also, head only portion 50, full body covering 20, and the Mane cover 80, may be constructed from various materials including a mixture of polyester, cotton, wool, rayon, lycra, or other durable natural or synthetic materials depending on the time of year needed for use and weather conditions. For example, in spring or mild weather, the embodiment may be constructed entirely of a single sheet of Lycra or some other stretchable material that will breathe allowing moisture out but adding some warmth. This will maintain the main purpose of the article to allow access to the Mane and Forelock. In winter or colder weather, the embodiment may be constructed of dual sheets of Lycra, a combination of Lycra and cotton linings, or other suitable material that will give warmth and maintain the access needed. In wet weather such as rain, the embodiment may be constructed of layers of material underneath that will stretch and conform to the body and waterproof outer materials to protect from rain.

What is claimed:

1. An improved apparatus for covering a horse head, neck, and body which allows on the horse access to the Mane and Forelock. The apparatus comprising:
a head portion having a shape substantially conforming to an equine head and allowing the ears to protrude through and visibility for the eyes via eye openings;
a neck portion attached to the head portion where the neck portion conforms closely to the volume of the equine neck, and
a body portion which covers from the withers of the horse to the tail and extending over the sides to the bottom of the belly; top of the legs

2. The apparatus of claim 1 wherein the neck portion of the hood contains a Mane opening running parallel to the horse's neck beginning approximately from the top of the Mane behind the ears running along the neck to the base of the Mane above the withers.

3. The apparatus of claim 2 further comprising:
a Mane opening which may be right handed (opening on the right side of the horse) or left handed (opening on the left side of the horse).
a Mane opening which may be used as a defined area for advertisement by stitching, embroidering, sewing additional material, or other means of adding wording such as barn names, owner names, websites, etc to the Mane covering.

4. The apparatus of claim 2 wherein the Mane opening is secured by an operational zipper or other suitable fastener running from the top of the Mane behind the ears to the bottom of the Mane just above the withers securing the Mane opening to the hood on the neck.

5. The apparatus of claim 1 wherein the muzzle end of the hood contains suitable cushioning material to add comfort and protection from rubbing between the muzzle of the horse and the hood article.

6. The apparatus of claim 1 wherein the hood section contains a Forelock opening vertical on the horse hood in the area between and below the ears and above but between the eyes where the Forelock is normally found on the horse.

7. The apparatus of claim 6 wherein the vertical Forelock opening is secured with an operational zipper or other suitable closure.

8. The apparatus of claim 1 wherein the neck portion of the hood contains an opening from the base of the chin to the chest.

9. The apparatus of claim 8 wherein the chest to chin opening may be secured with an operational zipper or other suitable closure.

10. The apparatus of claim 9 wherein the zipper is secured under the chin with a Velcro® closure to hold the zipper in the closed position and protect the animal from irritation from the zipper tab.

11. The apparatus of claim 1 further comprising:
an apparatus which may be constructed as a head, neck, and body covering in its entirety or as a head and neck covering separate unit used in conjunction with a body blanket
an apparatus which may be constructed with both Mane and Forelock openings or with either a Mane opening or Forelock opening only
